(19) United States
(12) Patent Application Publication
(10) Pub. No.: US 2021/0143915 A1
(43) Pub. Date: May 13, 2021

(54) METHOD AND APPARATUS FOR ACOUSTIC COMMUNICATION BETWEEN CLOSELY LOCATED DEVICES

(71) Applicant: Arsen Georgievich KHALATIAN, Moscow (RU)

(72) Inventors: Arsen Khalatian, Moscow (RU); Aleksandr Smityukh, Stavropolskiy Kray, G. Mikhaylovsk (RU)

(21) Appl. No.: 17/050,445

(22) PCT Filed: Apr. 8, 2019
(86) PCT No.: PCT/IB2019/052870

§ 371 Date: Oct. 25, 2020

Related U.S. Application Data
(60) Provisional application No. 62/663,279, filed on Apr. 27, 2018.

(51) Int. Cl. H04B 11/00

(52) U.S. Cl. CPC H04B 11/00

(57) ABSTRACT

The invention includes a method of acoustic communication between electronic devices comprising the following steps: placing the electronic devices close to each other; transmitting, by a first device, a synchronization signal and receiving, by a first device, a synchronization signal transmitted by a second device; transmitting, by the second device, the synchronization signal and receiving, by the second device, the synchronization signal transmitted by the first device; detecting a time overlap of synchronization cycles of the first device and the second device; selecting an acoustic communication channel, if the time overlap is detected. Power of the transmitted acoustic signal is adjusted so as the acoustic communication is performed within a predetermined distance range. The electronic devices are placed so as their screens are faced to each other and an upper portion of one electronic device is positioned essentially opposite to a lower portion of the other electronic device. Positions of the electronic devices may be determined, based on inertial sensor data. The invention may be used for direct transmission of a user data between the electronic devices, for direct transmission of a service information between the electronic devices for authentication of these devices so as to ensure a further user data exchange between them using other communication channels, and for enabling financial and/or non-financial transactions of users of the electronic devices.

### FIELD OF THE INVENTION

The invention relates to a method and an apparatus for providing acoustic communication between closely located devices. In particular, the invention may be used for direct data exchange between mobile devices or between mobile and fixed devices, or for exchange of registration information between them so as to further establish another connection between them for exchanging other information, e.g., for transmitting private data or for performing electronic payments.

### PRIOR ART

Use of acoustic communication for transmitting initial registration or synchronization information between portable electronic devices or between portable and fixed electronic devices is known since portable electronic devices first appeared. With developments in microelectronics and digital signal processing means, acoustic communication has been substantially improved; namely, multi-channel capability, increased transmission capacity of each channel as well as extended distance range and reliability of communication were implemented. Recently, an interest for use of short-range ultrasound acoustic communication for pairing mobile devices (e.g., by exchange of authentication tokens) has grown up, including pairing for further transmission of private data, electronic shopping, mobile banking, etc.

Patent documents US2017302886A1, US2015208034A1, US2015208033A1, US2013171930A1 and US2013106977A1 disclose a method of connecting a mobile communication device to a videoconference facility by transmitting an IP-address of the videoconference using acoustic communication between the mobile communication device and a videoconference device.

Patent document US2017111937A1 discloses a method of establishing acoustic communication between two mobile communication devices using their loudspeakers and microphones. The method includes frequency multiplexing.

Patent document US2017071017A1 also discloses a method of establishing acoustic communication between two mobile communication devices using their loudspeakers and microphones. Decision on establishing the communication is made in each device taking into account a direction of the other device, which is calculated based on phase difference between received acoustic signals.

Patent documents US2017019188A1 and US2014164629A1 disclose a method of transmitting a network address using ultrasound acoustic communication between a mobile communication device and a central communication device to ensure a further connection for providing audioconference or videoconference services.

Patent document US2016277925A1 discloses a method of providing access to an electronic device, depending on a distance between this device and another electronic device. The distance is determined using ultrasound acoustic communication between the devices.

Patent document US2016248779A1 discloses a method of authorizing an electronic device using acoustic communication for further payment transaction.

Patent documents US2016197648A1 and US2014134951A1 disclose a method of pairing mobile devices by transmitting a Bluetooth connection code using acoustic communication between the devices.

Patent document US2015261415A1 discloses a method of control of a mobile device by another device using acoustic communication in sonic or near ultrasonic frequency range.

Patent document US2015243163A1 discloses a method of control of domestic appliances using acoustic communication.

Patent document US2015201424A1 discloses a method of establishing a connection between devices using acoustic communication, where a frequency range for acoustic communication is allocated depending on priority level of each device.

Patent documents US2015012441A1, US2014154969A1, US2013332355A1, US2012151515A1, US2010256976A1 and US2004031856A1 disclose a method of establishing a connection between a fixed device or a portable device and an electronic card using acoustic communication in sonic or near ultrasonic frequency range. Level of the transmitted acoustic signal depends on ambient noise level.

Patent documents US2014355386A1 and US2012051187A1 disclose a method of data transmission using acoustic communication. Level of the transmitted acoustic signal and its frequency depend on ambient noise level and spectrum.

Patent document US2014279101A1 discloses a method of selecting a mobile electronic device using acoustic communication for further payment transaction.

Patent document US2013336497A1 discloses a method of data transmission using acoustic communication. Level of the transmitted acoustic signal depends on ambient noise level.

Patent document US2013301392A1 discloses a method of transmitting an authentication token to a mobile device using acoustic communication. The token is transmitted in a sound stream.

Patent document US2013275305A1 discloses a method of identification of a mobile electronic device using acoustic communication for further payment operation. Level of the transmitted acoustic signal depends on ambient noise level.

Patent document US2013268277A1 discloses a method of data transmission using acoustic communication in ultrasound frequency range for identification purpose prior to a further payment transaction.

Patent document US2013218571A1 discloses a method of user authentication by playing a voice record and recognition of a received acoustic signal.

Patent document US2013106975A1 discloses a method of connecting a mobile communication device to a videoconference facility using acoustic communication between the mobile device and a videoconference device.

Patent document US2012214416A1 discloses a method of establishing a connection between two mobile devices by transmitting an identification code using acoustic communication. The method may be used in payment systems.

Patent document US2012171963A1 discloses a method of establishing a connection between two mobile devices using acoustic communication. The method may be used for providing communication, e.g., between a mobile communication device and a wireless headset.

Patent document US2012134238A1 discloses a protocol of acoustic communication in ultrasonic frequency range, where level of the transmitted acoustic signal depends on ambient noise level.

Patent document US2010227549A1 discloses a method of pairing mobile devices by transmitting a PIN code for Bluetooth connection using acoustic communication between the devices.

Patent document US2005053122A1 discloses a method of transmitting article price information to a shopper's mobile device using acoustic communication. Level of the transmitted acoustic signal depends on ambient noise level.

Non-patent document [1] discloses methods of acoustic signal modulation for ultrasound data transmission.

Non-patent document [2] discloses a method of acoustic data transmission between smartphones in 18.5-20 kHz frequency range at a distance of about two meters with a data rate of about 100 bps.

Non-patent document [3] discloses signal spectrum parameters for ultrasound data transmission in 20.0-20.6 kHz frequency range. A connection establishment protocol is also disclosed.

Non-patent document [4] discusses theoretical grounds for non-coherent ultrasound data transmission (with no synchronization) at a distance of up to eight meters, while a high noise level (up to 80 dB) is present.

Non-patent document [5] discloses a method of ultrasound data transmission between smartphones in 50-105 kHz frequency range at a distance of about three meters with a data rate of about 56 kbps.

Non-patent document [6] discloses a method of ultrasound data transmission between smartphones in 50-110 kHz frequency range at a distance of about three meters with a data rate of about 63 kbps and at a distance of about ten meters with a data rate of about 30 kbps.

Non-patent document [7] discusses issues of ultrasound data transmission and personal data in view of GDPR.

Non-patent document [8] discloses an ultrasound data transmission at a frequency of about 21.5 kHz at a distance of up to four meters.

Non-patent document [9] discloses a method of providing security during ultrasound data transmission with no use of a channel encryption key.

Non-patent document [10] discloses an acoustic data transmission between smartphones in 8-20 kHz frequency range.

Non-patent document [11] discloses an ultrasound data transmission at a distance of up to 25 meters with data rate of about 16 bps.

Non-patent document [12] discloses an acoustic data transmission between smartphones at a frequency of about 8-20 kHz at a distance of about 20 centimeters with data rate of about 4.9 kbps.

Non-patent document [13] discloses an acoustic data transmission between mobile devices at a frequency of about 17-22 kHz at a distance of about 30 centimeters with data rate of about 2.76 kbps.

Non-patent document [14] discloses an acoustic data transmission between mobile devices at a frequency of about 17-22 kHz at a distance of about 30 centimeters with data rate of about 2.76 kbps.

Non-patent document [15] discloses a method of establishing a WiFi connection between mobile devices, based on analysis of ambient noise (noise signature).

Non-patent document [16] discloses a method of establishing a WiFi connection between mobile devices, based on analysis of ambient noise (noise signature).

Non-patent document [17] discloses software for acoustic data transmission (in particular, for contactless payment systems) in 16.5-19 kHz frequency range using a heterodyne demodulator (with no use of Fast Fourier Transform).

The prior art documents mainly focus either at general idea of using acoustic data transmission for pairing devices, including mobile devices, for further establishing a communication channel between them using other (conventional) communication channels like cell communication (including minicell, microcell, picocell communication, etc.), WiFi, Bluetooth and so on, or at engineering aspects of acoustic data transmission per se, namely, modulation methods, ciphering, etc. A problem of automatic establishing and maintaining initial full duplex communication between devices for exchange of authentication tokens (with no preliminary determination of transmission or receiving mode of each device) is not solved in the prior art. This problem includes optimal selection of acoustic data transmission parameters, in particular, selection of signal frequency, signal power, priority of transmission, and data rate, so as the connection would be established automatically (i.e., with no additional actions by a user), fast, reliably, as comfortably as possible and in intuitively obvious manner for the user, but at the same time securely (in view of information security) and as insensibly as possible.

### SUMMARY OF THE INVENTION

The above-indicated problem is solved by implementation of a method of acoustic communication between electronic devices, the method including the following actions:
placing the electronic devices close to each other;
transmitting, by a first device, a synchronization signal and receiving, by the first device, a synchronization signal transmitted by a second device;
transmitting, by the second device, the synchronization signal and receiving, by the second device, the synchronization signal transmitted by the first device;
detecting a time overlap of synchronization cycles of the first device and the second device;
selecting an acoustic communication channel, if the time overlap is detected.

If the time overlap of the synchronization cycles is not detected, a pseudorandom delay may be introduced to the synchronization signal of at least one of the electronic devices. If the time overlap of the synchronization cycles is detected, priority (i.e., an order in time) of the synchronization signals of the first and second devices may be further determined and the acoustic communication channel may be selected, based on the priority of the synchronization signals.

Selection of the acoustic communication channel may include selection of frequency and/or time resources of the acoustic communication channel. The frequency resources may be selected, depending on a number of acoustic sensors in each of the electronic devices. Power of the transmitted acoustic signal may be selected so as to ensure the acoustic communication within a predetermined distance range only.

Power of the transmitted acoustic signal may be adjusted, depending on a weighted noise value, which may be determined, based on a forecast for a predetermined point of time in the future. This forecasting may be done on a basis of historical data of the weighted noise value, and/or on a basis of historical data of a cumulative noise spectrum. The forecasting may be done using a linear extrapolation or a non-linear extrapolation. Alternatively, the forecasting may be done using a neural network.

The electronic devices may be placed so as their screens are faced to each other and at least one acoustic sensor of each device is positioned close to at least one acoustic emitter of the other device. In particular, the electronic devices may be placed so as their screens are faced to each other and an upper portion of one electronic device is positioned essentially opposite to a lower portion of the other electronic device. Positions of the electronic devices may be determined, based on inertial sensor data.

The method of acoustic communication may be used in direct transmission of user data between the electronic devices, in transmission of a service information between the electronic devices for authentication of these devices so as to ensure a further user data exchange between them using other communication channels, and to enable financial and/or non-financial transactions of the electronic device users.

The above-indicated problem is solved by implementation of a device for acoustic communication, the device comprising one or more acoustic sensors connected to an ambient noise analyzer, and one or more acoustic emitters connected to a regulator of acoustic signal transmission power. The analyzer is connected to the regulator and configured to forecast ambient noise near the device. The regulator is configured to provide acoustic communication within a predetermined communication distance range, based on the ambient noise forecast.

The ambient noise analyzer may comprise an analogue to digital converter (ADC), a spectrum analyzer, a weighted noise level measurement unit, a multiplier, a comparator, a register of predetermined values of weighted noise level, a delay line, a noise parameter change rate measurement unit, and a forecast unit.

The ambient noise analyzer may further comprise at least one feedback circuit connected to the forecast unit and comprising a multiplier, a delay line, and a comparator. Moreover, the ambient noise analyzer may further comprise a storage for cumulative noise spectrum.

Forecast of the ambient noise may be done by the forecast unit using extrapolation of values of weighted noise level onto a predetermined extrapolation horizon. The extrapolation of weighted noise level values may be based on current data of the noise parameter change rate measurement unit. The extrapolation of weighted noise level values may also be based on historic data of the noise parameter change rate measurement unit. Moreover, the extrapolation of weighted noise level values may be based on data of the storage for cumulative noise spectrum.

Forecast of the ambient noise may be done by the forecast unit using a neural network. Selection of the method of forecasting the ambient noise may be made, based on a signal of the feedback circuit.

The device for acoustic communication may be used for direct transmission of user data between the electronic devices, for transmission of a service information between the electronic devices for authentication of these devices so as to ensure a further user data exchange between them using other communication channels, and to ensure financial and/or non-financial transactions of the electronic device user.

### BRIEF DESCRIPTION OF DRAWINGS

FIG. 1 shows generalized schematic diagrams illustrating configuration of systems, where acoustic data transmission is used for direct data exchange between devices or for transmission of authentication tokens so as to further establish a connection between these devices using other communication channels.

FIG. 2 shows a block diagram of a device involved in acoustic data transmission, illustrating basics of transmission power adjustment for an acoustic signal, according to the invention.

FIG. 3 shows a block diagram of an ambient noise analyzer.

FIG. 4 shows a graph of acoustic communication distance depending on signal/noise ratio for different values of acoustic signal power.

FIG. 5 shows mutual position options for mobile devices while attempting establishment of acoustic communication between them.

FIG. 6 shows an example of a frequency spectrum of acoustic communication, when acoustic signal transmission frequency differs from control frequencies.

FIG. 7 shows an example of a frequency spectrum of acoustic communication, when measurements are performed at the acoustic signal transmission frequency at time points different from acoustic signal transmission time points.

FIG. 8 shows time diagrams of device synchronization signals during establishing acoustic communication.

FIG. 9 shows time diagrams of device synchronization signals having synchronization cycles with different phase relations.

FIG. 10 shows a block diagram of an exemplary algorithm for synchronization and allocation of a communication channel for two devices, based on determination of synchronization cycle overlap for these devices.

FIG. 11 shows a block diagram of an exemplary algorithm for synchronization and allocation of a communication channel for two devices, based on determination of time sequence of synchronization signals of these devices.

FIG. 12 shows a block diagram of an exemplary algorithm for synchronization and allocation of a communication channel for two devices, based on pseudorandom synchronization channel selection.

### DETAILED DESCRIPTION OF EMBODIMENTS

In a system, which generalized exemplary diagrams are shown in FIG. 1, acoustic data transfer is used for direct transmission of user data between the electronic devices or for transmission of authentication tokens. Tokens contain service information providing authentication of the devices so as to ensure a further user data exchange between them using other communication channels.

The acoustic data transfer may be used in a number of scenarios including but not limited to the following cases.

(A) Direct exchange of small amounts of data between the devices, including mobile devices, via acoustic communication. Examples of these data may be electronic visit cards, identifiers of social network accounts, personal Internet site addresses, etc.

(B) Pairing devices, including mobile devices, for further exchange of substantial amounts of data between them. The data exchange between these devices may include transfer of text, images, sounds, etc. formed as files or online streaming, and it may be done using usual (non-acoustic) wireless communication channels like satellite, mobile 3G, 4G, 5G, WiFi, Bluetooth channels, etc.

(C) Pairing devices, including mobile devices, for further exchange of data between them via an external service provider. The external service provider may be located in a server (local, remote or distributed), in cloud facilities, etc., and access to the provider may be implemented by usual (non-acoustic) wireless communication channels like satellite, mobile 3G, 4G, 5G, WiFi, Bluetooth channels, etc.

(D) Transmission of identification information from the mobile devices so as to further perform a financial transaction. The financial transaction may be a bank transfer, a payment for goods or services via a payment system, an exchange transaction, a cryptocurrency transaction, etc. Access to a corresponding infrastructure may be provided using usual (non-acoustic) wireless communication channels (satellite, mobile 3G, 4G, 5G, WiFi, Bluetooth channels, etc.), wired communication channels or optical communication channels.

(E) Transmission of identification information from the mobile devices so as to further perform a non-financial transaction. The non-financial transaction may be filing requests, petitions, inquiries, applications and other communications with state or municipal authorities, courts and non-government organizations, including requests for governmental services, signing documents with a digital signature, blockchain transactions, etc. Access to a corresponding infrastructure may be provided using usual (non-acoustic) wireless communication channels (satellite, mobile 3G, 4G, 5G, WiFi, Bluetooth channels, etc.), wired communication channels or optical communication channels.

It should be apparent, that the above-indicated examples are illustrative only and that the configurations of FIG. 1 may be used in various ways. For example, the system of case (C) may be used for performing a financial transaction by transmission a data of a predetermined format from one device to another device, which data determines the transaction (in particular, a payment for goods or services, a loan, a recovery of a debt. etc.) and contains identifiers of the transaction parties and transaction validation means, so the data may be further presented to a financial organization for settlement.

The above-described functions may be implemented in a separate dedicated application. In this case, it would be enough to launch the application in two devices to establish an acoustic communication between these devices. Further actions related to synchronization, allocation a channel for the acoustic communication, monitoring its parameters, regulating power of the transmitted acoustic signal, etc. are performed automatically. The user does not need to select a partner device, confirm anything, input confirmation codes, etc., i.e., to perform all those actions, which are usually required for pairing devices using Bluetooth or Direct WiFi communication channels.

As an alternative, the above-described functions may be implemented by a corresponding software module for a third-party application. The software module may be provided by the developer of this technology, and the third-party application may be an Internet-based banking application, a cryptocurrency transaction application, an application for financial transactions involving other legal quasi-money like Yandex-money, Kiwi, PayPal, Webmoney, etc.

The following acoustic communication parameters are selected or optimized during establishing the acoustic communication between the devices: power of transmitted signal, frequency properties of the signal, and time properties of the signal.

Power Adjustment of the Acoustic Signal

FIG. 2 shows a block diagram of a device involved in acoustic data transmission, including mobile device 1, mobile device 2 or other device 3. It illustrates basics of transmission power adjustment for an acoustic signal, according to the invention.

A mobile device 1 comprises at least one loudspeaker 101, at least one microphone 102, an acoustic signal power regulator 103, and an ambient noise analyzer 104. The loudspeaker 101 may be a main loudspeaker of the mobile device used for usual voice communication between users (i.e., with no use of speakerphone function), a speakerphone loudspeaker or any other acoustic emitter capable of emitting an acoustic signal with required parameters. The microphone 102 may be a main microphone of the mobile device used for usual voice communication between users, an additional microphone used in adaptive noise cancellation systems, a microphone grid having adjustable directional pattern or any other single or distributed acoustic sensor capable of sensing an acoustic signal with required parameters.

The acoustic signal power regulator 103 is connected to the loudspeaker 101, thus providing power adjustment of the acoustic signal to be emitted by the loudspeaker 101, according to the method of the invention. The regulator 103 may be a digital device, an analogue device, or a combined device and may include DAC(s), ADC(s), amplifier(s), comparator(s), switch(es), DSP(s), FPGA(s), ASIC(s), etc., when necessary. Circuitry of the regulator 103 is not limited to any certain solution; basics of its operations and general approaches to its implementation are well-known to persons skilled in the art, therefore detailed description of this unit is omitted for brevity.

In some embodiments of the invention, the regulator 103, in addition to adjust power, is capable of amplitude-modulate the acoustic signal to be emitted by the loudspeaker 101. In particular, the emitted acoustic signal may be “framed” by a frame function, which facilitates eliminating audible by-sound (usually perceived by the user as a specific clicking or crunching sound) emerging at steep fronts of the acoustic signal due to non-ideal step response of the loudspeaker 101. The frame function may be, e.g., a sines function within the 0 to π range of its argument value. As an alternative, the frame function may be a Gaussian function. It should be apparent to a person skilled in the art, that various options of the frame function may be used in the invention.

In addition to eliminating audible by-sound, using the frame function ensures a distinct spectral signature, thus facilitating more effective detection of a synchronization signal and/or a data transmission signal.

The ambient noise analyzer 104 is connected to the microphone 102 and to the regulator 103, thus providing measurement of a weighted level of the acoustic noise near the mobile device, analysis of current amplitude-frequency characteristics of the noise, formation of the cumulative noise spectrum, and generation of a control signal supplied to the acoustic signal power regulator 103.

FIG. 3 shows a block diagram of the ambient noise analyzer 104. The analyzer 104 comprises an analogue-to-digital converter (ADC) 111, a spectrum analyzer 112, a weighted noise level gauge 113, a multiplier 114, a comparator 115, a predetermined weighted noise level register 116, a delay line 117, a noise parameter change rate gauge 118, a prediction unit 119, a multiplier 120, a delay line 121, a comparator 122 and a cumulative noise spectrum storage 123.

A signal is supplied from the microphone 102 to the ADC 111 and enters the spectrum analyzer 112 after its transformation into digital form. An amplitude-frequency characteristic of an acoustic signal received by the microphone 102 is supplied to the weighted noise level gauge 113 and to the cumulative noise spectrum storage 123.

The weighted noise level gauge 113 measures the noise level, taking into account a weighting function, and the measured value is supplied to the multiplier 114, and further to the comparator 115. The weighted noise level register 116 supplies information related to predetermined weighted noise levels to the comparator 115. Based on comparison of the weighted noise level after the multiplier 114 and the predetermined weighted noise levels stored in the register 116, the comparator 115 generates a control signal supplied to the regulator 103 in order to adjust power of the acoustic signal to be emitted by the loudspeaker 101. These devices constitute a first loop for acoustic signal power adjustment, which is capable of self-sufficient operation and implementation of the adjustment, when change in the ambient noise conditions is relatively slow.

The weighted noise level value is supplied to the noise parameter change rate gauge 118 both directly and via the delay line 117, so the gauge 118 determines rate and sign of the noise characteristic variations, i.e., data of how much the weighted noise level increases or decreases in time. This data is supplied form the gauge 118 to the prediction unit 119, which provides a forecast of weighted noise level change for a predetermined point of time in the future by extrapolation of the weighted noise level supplied form the gauge 113 onto an extrapolation horizon. The forecast information is further transferred to the multiplier 114 along with the weighted noise level value received from the gauge 113. A forecasted noise level is supplied form the multiplier 114 to the comparator 115, thus affecting the control signal further transferred to the regulator 103. The forecasted data is also supplied to the comparator 122 via the delay line 121, along with the weighted noise level value, so the comparator 122 compares the forecasted noise level value delayed by a time corresponding to the extrapolation horizon with the actual noise level value and outputs a feedback data related to the forecast accuracy to the prediction unit 119. These devices constitute a second loop for acoustic signal power adjustment, which is capable of more precise control under complicated ambient noise conditions.

Amplitude-frequency characteristic of the acoustic signal is fed from the spectrum analyzer 112 to the cumulative noise spectrum storage 123, where a cumulative noise spectrum, i.e., data of change of the amplitude-frequency characteristic in time, is formed and stored for a predetermined time period. This data is fed into the prediction unit 119, which is able to use the data for improving accuracy of weighted noise value prediction. These devices jointly form a third loop for acoustic signal power adjustment, which in some cases provides more precise regulation in a complicated noise environment.

Thus, the three-loop control provides acceptable accuracy of the acoustic signal adjustment to be emitted by the loudspeaker 101. It should be apparent that the above description and referred drawings relate to one of possible implementations of power adjustment for the acoustic signal to be emitted, and that persons skilled in the art may devise other implementation options based thereon, which options remain in the scope of protection of this invention defined by the appended set of claims.

When the above implementation of three-loop control does not provide acceptable accuracy of power adjustment for the acoustic signal to be emitted by the loudspeaker 101, then predetermined weighted noise values stored in the predetermined weighted noise level register 116 may be adjusted using an additional control signal from the comparator 122 (shown as a dashed line in FIG. 3).

FIG. 4 shows signal to noise ratio (SNR) value of an acoustic signal received by the microphone 102 as a function of a distance d between the source and the receiver of the acoustic signal. For sake of better visualization, this dependence is shown in a simplified (linear) form for a steady white noise. The value of SNRₘᵢₙ determines minimal value of SNR, which ensures acoustic communication with predetermined parameters (in particular, parameters related to reliability and data transmission rate). As it may be seen in FIG. 4, decreasing the transmission power of the acoustic signal from P_{signal1} to P_{signal2} decreases distance of acoustic communication with predetermined parameters from dₘₐₓ₁ to dₘₐₓ₂.

Precise regulation of the acoustic signal emission power provides possibility of communication using an acoustic channel, when devices are located in a predetermined range of distance between them. In other words, the acoustic signal emission power is set so as the devices located in a predetermined range of distance between them may exchange authentication tokens in a fast and reliable manner, while interception of these tokens by third party means is impossible or highly hindered. Moreover, it should be taken into account that excessive acoustic signal emission power, e.g., in a range of 10-22 kHz may cause uncomfortable feeling in some people and pet animals; therefore, this is one more ground to reasonably limit the emission power.

FIG. 5 illustrates three situations related to establishing acoustic communication between the mobile devices 1 and 2. In situation A, the distance is too long for establishing acoustic communication with predetermined parameters, so the acoustic communication is not established, as the signal to noise ratio is below SNRₘᵢₙ. As the mobile devices 1 and 2 move closer, the signal to noise ratio increases and becomes over SNRₘᵢₙ value at a certain moment of time (in situation B), i.e., the distance is within dₘₐₓ and acoustic communication is established.

Situation C is even more favorable for establishing acoustic communication between the mobile devices 1 and 2. In particular, loudspeakers and microphones of the mobile devices 1 and 2 are located at a small distance from each other and substantially opposite to each other, and this configuration increases level of received acoustic signal. Therefore, the acoustic communication may be established at a higher environmental noise level or a higher data rate and/or reliability of the acoustic communication may be ensured at the same environmental noise level.

The term “substantially” used in the description and claims means that the corresponding feature appears at a degree sufficient for achieving the purpose of the invention and for attaining its technical result. In particular, placing one mobile device so as its upper portion is located opposite to lower portion of the other mobile device as shown in situation C of FIG. 5, means that these devices may be shifted one relative to the other, e.g., by 10%, 20%, 30% or 50% along longitudinal and/or transversal axes of these devices. However, acoustic sensor of one of these electronic devices is located within an area of, e.g., −3 dB, −6 dB or −12 dB of maximum level of directional emission pattern of the acoustic emitter of the other electronic device and vice versa. Specific numeric values may depend on configuration and characteristics of these mobile devices as well as on the distance between them.

Moreover, positioning mobile devices in situation C is convenient and intuitive for the device users. In particular, this position corresponds to position of hands during a handshake, when the mobile devices 1 and 2 are oriented in a vertical plane (i.e., when the picture of situation C is a top view), and this position is convenient for users located one opposite to the other. This position is also convenient for users located side-by-side, e.g., in seats next to each other in a vehicle. In this case the mobile devices 1 and 2 may be oriented in a horizontal plane and one of them may be positioned above the other (i.e., when the picture of situation C is a side view).

When establishing acoustic communication in situation C, positions of the mobile devices 1 and 2 derived from inertial sensor signals of the mobile devices 1 and 2 may be additionally taken into account. Examples of the inertial sensors may be an accelerometer and a gyroscope. Moreover, positions of the mobile devices 1 and 2 may be derived from signals of another sensor types, e.g., a magnetic field sensor (a magnetometer).

The most important functions employed in regulation of the acoustic signal emission power are described below.

Determination of a Weighted Noise Level

FIG. 6 shows an example of a frequency spectrum when frequency f_{signal} of the transmitted acoustic signal does not coincide with control frequencies f_{control}ⁱ and f_{control}^{j}, which number is predetermined and limited by a frequency resolution of the ADC 111. In one example, the noise level in a predetermined frequency range may be calculated as a root-mean-square value of all set A elements, the set A comprising noise levels at the control frequencies:

$$A = \{ {P}_{{f}_{control}^{i}} \vert i = 1 … n \} ⋃ \{ {P}_{{f}_{control}^{j}} \vert j = 1 … k \} ,$$

where n and k are numbers of the control frequencies below and above the signal frequency f_{signal}, correspondingly. In another example, the noise level in a predetermined frequency range may be equal to a maximum element of the set A. In yet another example, the noise level in a predetermined frequency range may be calculated using a weighting function. Basics of using weighting functions are well-known to persons skilled in the art; therefore, a detailed description of this solution is omitted for brevity.

If the transmitted acoustic signal frequency does not coincide with the control frequencies, the weighted noise level may be determined on an ad hoc basis at arbitrary time moments. If the transmitted acoustic signal frequency coincides with one of the control frequencies, the weighted noise level shall be determined at time moments, when the acoustic signal is not transmitted.

FIG. 6 shows a case, where measurements are performed at the transmission frequency of acoustic signal and at time moments t_{control}ⁱ, which differ from the moment t_{signal} of transmission of the acoustic signal. In one example, the noise level in a predetermined frequency range may be equal to root-mean-square value of a noise level at the control frequencies and at time moments of a set B:

B={t_{control}ⁱ|tₒₙₜᵣₒₗⁱ∈t; t_{control}ⁱ≠t_{signal}; i=1 . . . z},

where z is a maximum possible number of measurements at control frequency i in a predetermined time range; this number is limited by a frequency resolution of the ADC 111. In another example, the noise level in a predetermined frequency range may be equal to a maximum value of the noise level at the control frequencies and at the time moments of a set B. In yet another example, the noise level in a predetermined frequency range may be calculated using a weighting function. Basics of using weighting functions are well-known to persons skilled in the art; therefore, a detailed description of this solution is omitted for brevity.

In an alternative implementation of the invention, the noise level in a predetermined frequency range may be measured on an ad hoc basis at arbitrary time moments. Results of measurements at the acoustic signal transmission frequency performed during the transmission may be ignored, and the weighted noise level may be determined, based on results of measurements at other control frequencies.

Prediction of the Weighted Noise Level

Prediction of the weighted noise level is performed in the prediction unit 119, based on data of how the weighted noise level received from the noise parameter change rate gauge 118 is increased or decreased in time. The prediction is performed by extrapolation of the noise level received from the weighted noise level gauge 113 onto an extrapolation horizon, according to the data received from the gauge 118.

Persons skilled in the art are aware that extrapolation accuracy depends on extrapolation base length, distance of the extrapolation horizon, age of the data to be extrapolated and noisiness of the data. The distance of the extrapolation horizon is defined by a value of signal processing latency during regulation of the emitted acoustic signal, which latency is to be compensated. This distance may be, e.g., from 20 ms to 80 ms in various options of the invention implementations. The age of the data to be extrapolated may be decreased by using most recent data while analyzing the noise environment; it should be clear that in fact the age of data is linked to the extrapolation base length. The noisiness of the data to be extrapolated is defined by noise parameters of the mobile device 1 equipment and it may be quite low with use of modern technical solutions. Therefore, extrapolation base length has to be discussed in details.

In a simplest example, the prediction unit 119 performs linear extrapolation and yields a predicted weighted noise level for a predetermined moment of time in the future. In this case, the extrapolation base length is defined by the delay duration of the delay line 117.

In order to improve accuracy of prediction of the weighted noise level, the prediction unit 119 may accumulate data received from the gauge 118 during a predetermined period of time and perform extrapolation using historic data of the gauge 118. In this case, the extrapolation base is determined by a predetermined period of storing the historic data of the gauge 118. As this period may be long enough, accuracy of prediction of the weighted noise level may be improved substantially in comparison with the simplest example described in the above. Moreover, presence of historic data of the gauge 118 in the prediction unit 119, which are available for analysis, allows implementing a non-linear extrapolation, e.g., by taking into account first and/or second derivative of change in time of the historic data of the gauge 118. This approach provides additional improvement of prediction accuracy for the weighted noise level.

To further improve accuracy of prediction of the weighted noise level, the amplitude-frequency characteristic of an acoustic signal received by the microphone 102 is determined by the spectrum analyzer 112 and fed to the prediction unit 119, along with amplitude-frequency characteristics of this signal (i.e., cumulative noise spectrum data) stored in the cumulative noise spectrum storage 123.

In some cases, taking into account the historic cumulative noise spectrum data allows substantially improving accuracy of prediction of the weighted noise level, in particular, when the noise have a periodic nature, e.g., by detecting an envelope function for the noise and applying thereof to the noise level received from the gauge 113. In addition, taking into account the historic cumulative noise spectrum data allows not only more precise selecting the approximation function for extrapolation of the weighted noise level (as it is done using the historic data of the gauge 118), but also adjusting, when appropriate, the weighting function used for determination of the weighted noise level.

In some cases, analysis of the historic cumulative noise spectrum data may be preferably done using a neural network. The neural network may be implemented in the prediction unit 119 or it may be implemented as a separate device (not shown in the drawings). In some options of the invention implementations, the neural network may be in a form of a “cloud” equipment or a “cloud” service.

The extrapolation methods described in the above (i.e., linear extrapolation based on a current signal value received from the gauge 118, linear or non-linear extrapolation based on a current signal value plus historic signal values received from the gauge 118, linear or non-linear extrapolation based on a current value plus historic values of the historic cumulative noise spectrum data) may be selected, depending on a feedback signal, which, in turn, depends on accuracy of prediction of the weighted noise level by the prediction unit 119. In other words, when a currently used method does not ensure required prediction accuracy, then the prediction unit 119 may switch to another extrapolation method.

In an alternative option, the prediction unit 119 may use multiple extrapolation methods simultaneously and select one method among them, which provides the best prediction accuracy under current noise environment. In this case, multiple feedback loops comprising the multiplier 120, the delay line 121 and the comparator 122 may be employed, and the analyzer 104 may further comprise a switch (not shown in FIG. 3), that allows selecting a source of a signal to be fed to the multiplier 114.

### Synchronization During Establishing Acoustic Communication

FIG. 8 shows time domain diagrams of synchronization signals for the mobile devices 1 and 2 shown in FIG. 5 during establishing acoustic communication. It should be apparent, that reference to the mobile devices 1 and 2 herein is illustrative and that the invention equally may be implemented with use of other devices, including wearable, mobile or fixed devices, having appropriate characteristics.

The mobile device 1 transmits a synchronization signal having power value Pₜᵣ¹ and duration Δtₜᵣ¹ in a time slot between t₀¹ and t₁¹. After that the mobile device 1 stops transmission and receives a synchronization signal having duration Δt_{rc}¹ from the other mobile device 2 in a time slot between t₁¹ and t₂¹. The mobile device 2 transmits a synchronization signal having power value Pₜᵣ² and duration Δₜᵣ² in a time slot between t₀² and t₁². After that the mobile device 2 stops transmission and receives a synchronization signal having duration Δt_{rc}² from the mobile device 2 in a time slot between t₁² and t₂². The time slot between t₁¹ and t₂¹ is a synchronization cycle of the mobile device 1 and the time slot between t₁² and t₂² is a synchronization cycle of the mobile device 2.

In this example, durations of the synchronization cycles are equal for the mobile devices 1 and 2, and the transmission duration is equal to the reception duration for each of the mobile devices. Generally, durations of the synchronization cycles may differ for the mobile devices 1 and 2, and the transmission duration may be not equal to the reception duration for each of the mobile devices. Moreover, transmission duration and/or reception duration may differ for different mobile devices. In any case, to provide possibility of synchronization, reception duration Δt_{rc}ⁱ must exceed transmission duration Δₜᵣⁱ in a two-step synchronization cycle.

It should be noted that the examples described herein illustrate a two-step synchronization cycle. However, the synchronization cycle may comprise more steps. Steps here mean transmission periods, which may have different durations, interleaved with reception periods, which also may have different durations. For example, two synchronization signal transmission periods Δtₜᵣ₁¹ and Δtₜᵣ₂¹ and two synchronization signal reception periods Δt_{rc1}¹ and Δt_{rc2}¹ may be implemented in the mobile device 1. In another example, two synchronization signal transmission periods and three synchronization signal reception periods may be implemented. The synchronization procedure may be more complicated in this case, but the principles of synchronization remain substantially the same.

As shown in FIG. 8, duration Δt of overlap of the reception period in the mobile device 1 and the transmission period in the mobile device 2 is a time period, when the mobile device 1 is able to receive a synchronization signal from the mobile device 2. The duration Δt may be between 0 and Δt_{rc}¹. Depending on correlation of time moments t₀¹ and t₀², the synchronization signal cycle of the mobile device 1 may pass ahead of or drop behind the synchronization signal cycle of the mobile device 2. It should be apparent, that advance or lag of the synchronization signal cycle of one mobile device relative to another mobile device is defined by order of passing a certain phase of the cycle, e.g., a time point of start of the synchronization signal transmission or a time point of start of the synchronization signal reception.

FIG. 9 shows situation (A), where the synchronization signal cycle of the mobile device 1 passes ahead of the synchronization signal cycle of the mobile device 2; situation (B), where the synchronization signal cycle of the mobile device 1 drops behind the synchronization signal cycle of the mobile device 2; and situation (C), where it is not possible to determine if the synchronization signal cycle of the mobile device 1 passes ahead of or drops behind the synchronization signal cycle of the mobile device 2, as duration Δt is equal to duration Δt_{rc}².

As a result of performing synchronization, an acoustic communication channel is allocated to each device participating in the synchronization procedure for providing information exchange, in particular, for transmitting and receiving authentication tokens. In a simplest illustrative example, there may be two such devices, e.g., the mobile devices 1 and 2. Generally, more than two such devices may be used.

FIG. 9 shows a diagram of exemplary algorithm of synchronization and allocation of a communication channel for two mobile devices 1 and 2. This algorithm is based on detection of overlap of synchronization cycles of these devices.

In step 201, communication channel “A” is listened to in order to determine if it is free or busy. In step 202, presence of data exchange in this channel is checked. If there is a data exchange in this channel (i.e., when the channel is busy), then the algorithm goes to step 207 of selection of another communication channel (i.e., communication channel “B”). If channel “A” is free, then the algorithm goes to step 203 of determination of synchronization cycles overlap. It should be noted that in this situation the second communication channel is considered free a priory, as this algorithm is applicable to simultaneous use of two devices only.

In step 203, synchronization is performed, as described in the above, i.e., synchronization signals are transmitted and received by devices among which an acoustic communication is to be established. During synchronization, overlap of synchronization cycles in a synchronization channel corresponding to channel “A” is detected, e.g., as shown in FIG. 9.

In step 204, it is checked if overlap of synchronization cycles is detected during synchronization. If the overlap is detected, the algorithm goes to step 206 of selecting channel “A”. If the overlap is not detected, the algorithm goes to step 205 of introducing a pseudorandom delay.

In step 205, a delay is introduced to the synchronization signal of one of the mobile devices 1 and 2. Amount of the delay has a pseudorandom nature. The delay amount may be determined by use of a pseudorandom number generator, which implementation details are well-known to persons skilled in the art; therefore, a description of a method of selecting the delay is omitted. From a pragmatic point of view, the delay should not be less than a resolution of hardware and software algorithms employed in the devices, between which an acoustic communication is to be provided. Nevertheless, the delay should not be more than a reasonable value, so as to avoid unnecessary delays in synchronization and communication setup process. For example, the delay may be in a range of 5-60 ms. After introducing a pseudorandom delay, step 203 of synchronization is performed again.

Thus, a simple method of distribution or allocation of communication channels among two mobile devices 1 and 2 may be implemented, based on detection of overlap of synchronization cycles.

Channels “A” and “B” may differ in frequency properties, time properties, codes of their signals, etc. The predetermined weighted noise levels stored in the register 116 may be different for channels “A” and “B”, so regulation of their power may be implemented in different manners.

FIG. 11 shows a diagram of another exemplary algorithm of synchronization and allocation of a communication channel for two mobile devices 1 and 2. This algorithm is based on detection of priority of synchronization signals of these devices.

In step 301, synchronization is performed as described in the above. During synchronization, overlap of synchronization cycles is detected, e.g., as shown in FIG. 9.

In step 302, it is checked if overlap of synchronization cycles is detected during synchronization. If the overlap is detected, the algorithm goes to step 303 of determination of priority of the synchronization signals. If the overlap is not detected, the algorithm goes to step 305 of introducing a pseudorandom delay.

In step 303, priority of the synchronization signals is determined for the mobile devices 1 and 2.

In step 304, it is checked if priority of the synchronization signals has been determined for the mobile devices 1 and 2 (i.e., if there is a situation, when the synchronization signal cycle of the mobile device 1 passes ahead of or drops behind the synchronization signal cycle of the mobile device 2). As shown in FIG. 9, a situation is possible when duration Δt is equal to duration Δt_{rc}² and the priority determination for the synchronization signals of the mobile devices 1 and 2 is not possible. If priority of the synchronization signals is not determined, the algorithm goes to step 305 of introducing a pseudorandom delay. If priority of the synchronization signals is determined, the algorithm goes to step 306 of checking the nature of the signal succession, advance or lag.

In step 305, a delay is introduced to the synchronization signal of one of the mobile devices 1 and 2, as described in the above. After introducing the pseudorandom delay, step 301 of synchronization is performed again.

In step 306, it is determined if the synchronization signal cycle of the mobile device 1 passes ahead of or drops behind the synchronization signal cycle of the mobile device 2. If the synchronization signal cycle of the mobile device 1 passes ahead of the synchronization signal cycle of the mobile device 2, the algorithm goes to step 307 of selecting the acoustic communication channel “A”. If the synchronization signal cycle of the mobile device 1 goes drops behind the synchronization signal cycle of the mobile device 2, the algorithm goes to step 308 of selecting acoustic communication channel “B”.

Thus, a simple method of distribution or allocation of communication channels among two mobile devices 1 and 2 may be implemented, based on priority of the synchronization signals, with no need of listening to the communication channels in advance.

FIG. 11 shows a diagram of yet another exemplary algorithm of synchronization and allocation of communication channels for two devices. This algorithm is based on pseudorandom selection of a synchronization channel.

In step 401, pseudorandom selection of synchronization channel j is performed among M available synchronization channels. The selection may be done using a pseudorandom number generator, which implementation details are well-known to persons skilled in the art; therefore, a description of a method of pseudorandom selection is omitted.

In step 402, the algorithm is branched to provide synchronization in synchronization channels having different synchronization parameters. In particular, for synchronization channel j selected in step 401, the following parameters are set in step 403: Δtₜᵣⁱ>0, Δt_{rc}ⁱ=0, for other synchronization channels, the following parameters are set in step 404: Δtₜᵣⁱ=0, Δt_{rc}ⁱ>0, which means transmission of synchronization signal in channel j with no listening to thereof, and listening to other channels with no transmissions of synchronization signals.

In step 405, M synchronization cycles are launched simultaneously. Each synchronization cycle is performed in a separate synchronization channel corresponding to a certain acoustic communication channel, in which a connection may be established.

In step 406, it is checked if overlap of synchronization cycles is detected in synchronization channel i during synchronization. If the overlap is detected, the algorithm goes to step 407; if the overlap is not detected, the algorithm goes back to step 401.

In step 407, it is determined how number i of synchronization channel, wherein overlap of synchronization cycles is detected, relate to number j selected in step 401. If i<j, then the algorithm goes to step 408, in which channel “A” is selected. If i>j, then the algorithm goes to step 409, in which channel “B” is selected. It should be noted, that in this option of the synchronization algorithm, overlap of synchronization cycles in channel j (i.e., when i=j) is not possible, as only transmission of a synchronization signal is performed in this channel, but not reception of a synchronization signal.

The exemplary options of implementation of a synchronization algorithm as described in the above have merely illustrative purpose and they should not be considered as limitations. Based on these examples, it should be apparent to persons skilled in the art how other options of the synchronization algorithm may be devised within scope of this invention.

Selection of a data transfer channel, based on acoustic characteristics of devices Mobile communication devices comprise at least one microphone. Most of modern mobile communication devices comprise at least two microphones, one of them is typically located in a lower portion of the device and intended for receiving user's voice during voice communication; the other one microphone or multiple microphones is/are usually located in an upper portion of the device and intended for receiving mainly ambient noise to implement one or another noise reduction system or to record sounds during rolling video. In some cases, at least two microphones form a microphone grid, which allows implementing a selective or dynamically adjustable directional pattern of such a microphone system.

In particular, when the mobile devices are disposed according to situation B of FIG. 5 during paring, the directional pattern of the lower microphone of each of these devices is directed right away of the partner device. Moreover, the received acoustic signal is partially screened by the user's hand. The directional pattern of the upper microphone is directed more upwardly and screen effect by the user's hand does not occur.

In situation C of FIG. 5 during paring, the directional pattern of the lower microphone of each of these devices is also directed away of the partner device; however, the lower microphone is located close to a loudspeaker of the partner device. Therefore, the lower microphone provides a better signal-to-noise ratio for the received acoustic signal, than the upper microphone.

Generally, presence of multiple microphones provides better sensitivity of the microphone system in comparison with a device having one microphone typically located in a lower portion of the device. This difference in sensitivity is mainly apparent in an upper portion of the operational frequency range for acoustic communication.

Allocation of frequency resources for acoustic communication to a device may depend on the number of microphones in this device. In particular, if communication is established by two devices each having one microphone, then a low-frequency communication channel may be allocated to them. If communication is established by two devices each having multiple microphones, then a high-frequency communication channel may be allocated to them. If communication is established by two devices, one of them having one microphone and the other having multiple microphones, then a high-frequency communication channel for transmission and a low-frequency communication channel for reception may be allocated to the device having one microphone, while a low-frequency communication channel for transmission and a high-frequency communication channel for reception may be allocated to the device having multiple microphones. Moreover, devices having one microphone and devices having multiple microphones may transmit synchronization signals a priory in different frequency ranges, which configuration allows implementing a simplified synchronization procedure in some cases.

Detection of presence of multiple microphones may be performed, e.g., by receiving and recording a synchronization signal in stereo mode. The signal received by a device having one microphone will be recorded substantially as a monophonic signal (i.e., both channels of the recorded stereo signal will be technically identical). Contrary to that, the signal received by a device having multiple microphones will be recorded as a stereophonic signal (i.e., two channels of the recorded stereo signal will differ noticeably in amplitude and phase).

Thus, the invention provides a solution for establishing a full-duplex primary acoustic communication between devices in a fast, convenient and intuitive manner. The acoustic communication may be used for direct data exchange between the devices or for transfer of authentication tokens, which may be used in further data exchange using other (non-acoustic) communication means. In particular, the invention provides establishing acoustic communication in automatic mode, when no any actions are required from a user for switching transmission/reception modes, which is typical for non-full-duplex communication channels. No any actions are required from a user for selecting a partner device, issuing acknowledgements, inputting confirmation codes, etc., which are typical for establishing communication, e.g., using Bluetooth or Direct WiFi. Moreover, security of the connection is ensured by physical limitation of the communication distance and by the algorithm of establishing acoustic communication.

In addition, the invention allows solving a problem of optimal selection of parameters of acoustic data transfer, in particular, a problem of selecting frequency, power and priority of signals, as well as data transfer rate so as to ensure the communication to be fast, reliable, but secure (in view of information security) and as insensible as possible.

It should be noted that the above description covers only those steps, which are most essential for achieving the purpose of the invention. It should be apparent to persons skilled in the art, that some other actions may be required for ensuring functions of the acoustic communication system, e.g., connecting equipment, its initialization, launching appropriate software, transmitting and receiving instructions and acknowledgements, exchanging service data, etc., and their description is omitted herein for brevity.

It should also be noted that the method described in the above may be implemented using a hardware means and software means. The synchronization algorithm according to this invention may be performed by hardware, software or combined hardware/software means. In particular, the hardware for performing the above-disclosed method may be general purpose or customized computing means including central processor units (CPU), digital signal processors (DSPs), field programmable field arrays (FPGAs), application-specific integrated circuits (ASICs), etc. Signal and data processing in the above-disclosed method may be performed by one computing means or it may be performed by multiple computing means in a distributed manner.

Devices, methods and portions thereof mentioned in the description and drawings relate to one or more particular embodiments of the invention, when they are mentioned with reference to a numeral designator, or they relate to all applicable embodiments of the invention, when they are mentioned without reference to a numeral designator.

Devices and parts thereof mentioned in description, drawings and claims constitute combined hardware/software means, wherein hardware of some devices may be different, or may coincide partially or fully with hardware of other devices, if otherwise is not explicitly stated. The hardware of some devices may be located in different parts of other devices or means, if otherwise is not explicitly stated. The software may be implemented in a form of a program code contained in a storage device.

Sequence of steps in the method description provided herein is illustrative and it may be different in some embodiments of the invention, as long as its purpose is achieved and its result is attained.

Features of the invention may be combined in different embodiments of the invention, if they do not contradict to each other. The embodiments of the invention described in the above are provided as illustrations and they are not intended to limit the invention, which is defined in claims. All and any reasonable modifications, alterations, and equivalent replacements in design, configuration, and principle of operation are included into the invention scope.

### LIST OF DESIGNATORS FOR DEVICES AND PARTS THEREOF

1—mobile device
2—mobile device
3—other device
101—loudspeaker
102—microphone
103—acoustic signal power regulator
104—ambient noise analyzer
111—analogue-to-digital converter (ADC)
112—spectrum analyzer
113—weighted noise level gauge
114—multiplier
115—comparator
116—predetermined weighted noise level register
117—delay line
118—noise parameter change rate gauge
119—prediction unit
120—multiplier
121—delay line
122—comparator
123—cumulative noise spectrum storage

### LIST OF NON-PATENT LITERATURE

1. Nan Gao, Shigeru Shimamoto. Amplitude and phase modulation for ultrasonic wireless communication. International Journal of Wireless & Mobile Networks (IJWMN) Vol. 6, No. 2, April 2014.
2. Pascal Getreuer, Chet Gnegy, Richard F. Lyon, Rif A. Saurous. Ultrasonic communication using consumer hardware. IEEE Transactions on Multimedia, Vol. 20, No. 6, June 2018, doi: 10.1109/TMM.2017.2766049.
3. Tayyab Javed. Enabling indoor location-based services using ultrasound. A thesis submitted to the School of Computing in conformity with the requirements for the degree of Master of Science. Queen's University, Kingston, Ontario, Canada, January 2013.
4. Kwang Myung Jeon, Hong Kook Kim, Myung J. Lee. Non-coherent low-frequency ultrasonic communication system with optimum symbol length. International Journal of Distributed Sensor Networks, Volume 2016, doi: 10.1155/2016/9713180.
5. Wentao Jiang, William M. D. Wright. Ultrasonic wireless communication in air using OFDM-OOK modulation. IEEE International Ultrasonics Symposium, 3-6 Sep. 2014, doi: 10.1109/ULTSYM.2014.0251.
6. Wentao Jiang, William M. D. Wright. Multichannel ultrasonic data communications in air using range dependent modulation schemes. IEEE Transactions on Ultrasonics, Ferroelectrics, and Frequency Control, 63(1), pp. 147-155, doi: 10.1109/TUFFC.2015.2498479
7. Anna Lonka. Profiling through ultrasound technology, the right to privacy and the right to data protection. Thesis in Swedish Master of Law, Faculty Of Law, Stockholm University, Spring term 2018.
8. H Matsuoka, Y Nakashima, T Yoshimura. Acoustic communication system using mobile terminal microphones. NTT DoCoMo Technical Journal, Vol. 8, No. 2, 2006.
9. Bingsheng Zhang, Qin Zhan, Si Chen, Muyuan Li, Kui Ren, Cong Wang, Di Ma. PriWhisper: enabling keyless secure acoustic communication for smartphones. IEEE Internet of Things Journal, Volume 1, Issue 1, February 2014.
10. Qian Wang, Kui Ren, Man Zhou, Tao Lei, Dimitrios Koutsonikolas, Lu Su. Messages behind the sound: real-time hidden acoustic signal capture with smartphones. 22nd Annual International Conference on Mobile Computing and Networking, pages 29-41, doi: 10.1145/2973750.2973765.
11. Hyewon Lee, Tae Hyun Kim, Jun Won Choi, Sunghyun Choi. Chirp signal-based aerial acoustic communication for smart devices. IEEE Conference on Computer Communications (INFOCOM), 26 April-1 May 2015, doi: 10.1109/INFOCOM.2015.7218629.
12. Ed Novak, Zhuofan Tang, Qun Li. Ultrasound proximity networking on smart mobile devices for IoT applications. IEEE Internet of Things Journal (Early Access), doi: 10.1109/JIOT.2018.2848099.
13. G. Enrico Santagati, Tommaso Melodia. U-Wear: software-defined ultrasonic networking for wearable devices. Proceedings of the 13th Annual International Conference on Mobile Systems, Applications, and Services, pages 241-256, doi: 10.1145/2742647.2742655.
14. G. Enrico Santagati, Tommaso Melodia. A software-defined ultrasonic networking for wearable devices. IEEE/ACM Transactions on Networking, Vol. 25, No. 2, April 2017.
15. Alex Varshaysky, Adin Scannell, Anthony LaMarca, Eyal de Lara. Amigo: proximity-based authentication of mobile devices. UbiComp 2007: International Conference on Ubiquitous Computing, In: Krumm J., Abowd G. D., Seneviratne A., Strang T. (eds) UbiComp 2007. Lecture Notes in Computer Science, vol 4717. Springer, Berlin, Heidelberg, doi: 10.1007/978-3-540-74853-3_15.
16. Adin Scannell, Alex Varshaysky, Anthony LaMarca, Eyal de Lara. Proximity-based authentication of mobile devices. Int. J. Security and Networks, Vol. 4, Nos. 1/2, 2009.
17. Ivan Ozhiganov. NFC alternative: transferring data between mobile devices using ultrasound. 9 Oct. 2013. https://www.azoft.com/blog/nfc-alternative-ultrasound/

1. A method of acoustic communication between electronic devices comprising the following steps:
placing the electronic devices close to each other;
transmitting, by a first device, a synchronization signal and receiving, by the first device, a synchronization signal transmitted by a second device;
transmitting, by the second device, the synchronization signal and receiving, by the second device, the synchronization signal transmitted by the first device;
detecting a time overlap of synchronization cycles of the first device and the second device;
selecting an acoustic communication channel, when the time overlap is detected.

2. The method of claim 1, wherein, when the time overlap of the synchronization cycles is not detected, a pseudorandom delay is introduced to the synchronization signal of at least one of the electronic devices.

3. The method of claim 1, wherein, when the time overlap of the synchronization cycles is detected, priority of the synchronization signals of the first and second devices is determined and the acoustic communication channel is selected, based on the priority of the synchronization signals.

4. The method of claim 1, wherein the selection of the acoustic communication channel comprises selection of frequency and/or time resources of the acoustic communication channel.

5. The method of claim 4, wherein the frequency resources are selected, depending on a number of acoustic sensors in each of the electronic devices.

6. The method of claim 1, further comprising adjustment of the acoustic signal transmission power so as the acoustic communication is performed within a predetermined distance range.

7. The method of claim 6, wherein the acoustic signal transmission power is adjusted, depending on a weighted noise value.

8. The method of claim 7, wherein the weighted noise value is determined, based on a forecast for a predetermined point of time in the future.

9. The method of claim 8, wherein the forecasting is performed on a basis of historical data of the weighted noise value.

10. The method of claim 8, wherein the forecasting is performed on a basis of historical data of a cumulative noise spectrum.

11. The method of claim 8, wherein the forecasting is performed using a linear extrapolation.

12. The method of claim 8, wherein the forecasting is performed using a non-linear extrapolation.

13. The method of claim 8, wherein the forecasting is performed using a neural network.

14. The method of claim 1, wherein the electronic devices are placed at a predetermined distance from each other so as their screens are faced to each other and at least one acoustic sensor of each device is positioned close to at least one acoustic emitter of the other device.

15. The method of claim 14, wherein the electronic devices are placed so as an upper portion of one electronic device is positioned substantially opposite to a lower portion of the other electronic device.

16. The method of claim 15, wherein positions of the electronic devices are determined, based on inertial sensor data.

17. A use of the method of any of claims 1-16 during direct transmission of a user data between the electronic devices.

18. A use of the method of any of claims 1-16 during direct transmission of a service information between the electronic devices for authentication of these devices so as to ensure a further user data exchange between them using other communication channels.

19. A use of the method of any of claims 1-16 during financial and/or non-financial transactions of users of the electronic devices.

20. A device for acoustic communication, the device comprising one or more acoustic sensors connected to an ambient noise analyzer, and one or more acoustic emitters connected to a regulator of acoustic signal transmission power, wherein the analyzer is connected to the regulator and configured to forecast ambient noise near the device, and the regulator is configured to provide acoustic communication within a predetermined communication distance range, based on the ambient noise forecast.

21. The device of claim 20, wherein the ambient noise analyzer comprises an analogue to digital converter (ADC), a spectrum analyzer, a weighted noise level measurement unit, a multiplier, a comparator, a register of predetermined values of weighted noise level, a delay line, a noise parameter change rate measurement unit, and a forecast unit.

22. The device of claim 21, wherein the ambient noise analyzer further comprises at least one feedback circuit connected to the forecast unit and comprising a multiplier, a delay line, and a comparator.

23. The device of claim 21, wherein the ambient noise analyzer further comprises a storage for cumulative noise spectrum.

24. The device of any of claims 21-23, wherein the forecasting ambient noise is provided by the forecast unit using extrapolation of values of weighted noise level onto a predetermined extrapolation horizon.

25. The device of claim 24, wherein the extrapolation of weighted noise level values is based on current data of the noise parameter change rate measurement unit.

26. The device of claim 24, wherein the extrapolation of weighted noise level values is based on a historic data set of the noise parameter change rate measurement unit.

27. The device of claim 24, wherein the extrapolation of weighted noise level values is based on data of the storage for cumulative noise spectrum.

28. The device of any of claims 21-23, wherein the forecasting ambient noise is performed by the forecast unit using a neural network.

29. The device of claim 22, further configured to select a method of forecasting ambient noise, based on a signal of the feedback circuit.

30. A use of the device of any of claims 20-29 for direct transmission of a user data between the electronic devices.

31. A use of the device of any of claims 20-29 for direct transmission of a service information between the electronic devices for authentication of these devices so as to ensure a further user data exchange between them using other communication channels.

32. A use of the device of any of claims 20-29 for financial and/or non-financial transactions of users of the electronic devices.
